(19) United States
(12) Patent Application Publication
(10) Pub. No.: US 2019/0065913 A1
(43) Pub. Date: Feb. 28, 2019

(54) SEARCH METHOD AND INFORMATION PROCESSING APPARATUS

(71) Applicant: FUJITSU LIMITED, Kawasaki-shi (JP)

(72) Inventors: Masayuki KIDERA, Kawasaki (JP); Makoto Sakairi, Yokohama (JP); Serban Georgescu, London (GB)

(73) Assignee: FUJITSU LIMITED, Kawasaki-shi (JP)

(21) Appl. No.: 16/109,832

(22) Filed: Aug. 23, 2018

(30) Foreign Application Priority Data
Aug. 29, 2017 (JP) 2017-164550

(51) Int. Cl. G06K 9/66; G06K 9/62; G06K 9/46; G06K 9/00; G06F 17/50; G06F 17/30; G06N 3/04

(52) U.S. Cl. CPC G06K 9/66; G06K 9/6215; G06K 9/4604; G06N 3/0454; G06F 17/50; G06F 17/30271; G06K 9/00208

(57) ABSTRACT

A search method performed by a computer, includes, calculating a high-dimensional feature vector and a low-dimensional feature vector, the number of dimensions of the low-dimensional feature vector which is smaller than the number of dimensions of the high-dimensional feature vector, from images of an object captured from different visual line directions, specifying a search range of a similar image of a target object by using the low-dimensional feature vector, and searching for the similar image of the target object that satisfies a predetermined selection criterion in the specified search range by using the high-dimensional feature vector.

### CROSS-REFERENCE TO RELATED APPLICATION

This application is based upon and claims the benefit of priority of the prior Japanese Patent Application No. 2017-164550, filed on Aug. 29, 2017, the entire contents of which are incorporated herein by reference.

### FIELD

The embodiments discussed herein are related to a search method and an information processing apparatus.

### BACKGROUND

In a product development in recent years, various analyses and various verifications using a digital mockup or the like are applied by generating a product model in a virtual space of a computer using a three-dimensional CAD (Computer Aided Design) and utilizing a three-dimensional shape of the product model. These days, product development cycles are very short, so that when creating a product model by using the three-dimensional CAD, purchased parts are used as designed parts by registering CAD data of the purchased parts in a database as a library. Alternatively, a product can be developed in a short period of time by using parts designed for old machine models.

However, in a three-dimensional search of a product model using a database where three-dimensional CAD data of parts is accumulated, similarity is determined from features obtained by viewing each of parts and a product model from a plurality of directions, so that memory consumption during search is huge.

A technique is known which first searches database of compressed images in a low resolution in order to obtain a relative degree of coincidence between a search template and a candidate image and performs matching again by increasing the resolution of the candidate image when the degree of coincidence is greater than a certain threshold value.

However, the technique described above is a technique that searches for an image compressed using a wavelet compression technique from an image database by using a Fourier correlation technique, and an object is a two-dimensional image. Therefore, it is not possible to reduce the memory consumption when searching for a three-dimensional product model.

Related techniques are disclosed in the following documents:

Japanese Laid-open Patent Publication No. 10-55433,

Japanese Laid-open Patent Publication No. 2009-129337 and

Japanese Laid-open Patent Publication No. 2008-527473.

### SUMMARY

According to an aspect of the embodiments, a search method performed by a computer, includes, calculating a high-dimensional feature vector and a low-dimensional feature vector, the number of dimensions of the low-dimensional feature vector which is smaller than the number of dimensions of the high-dimensional feature vector, from images of an object captured from different visual line directions, specifying a search range of a similar image of a target object by using the low-dimensional feature vector, and searching for the similar image of the target object that satisfies a predetermined selection criterion in the specified search range by using the high-dimensional feature vector.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a system configuration example according to a first embodiment;

FIG. 2 is a diagram illustrating a hardware configuration;

FIG. 3 is a diagram illustrating a functional configuration example of a feature extraction circuit according to the first embodiment;

FIG. 4 is a flowchart diagram for explaining drawing/extraction processing;

FIG. 5 is a flowchart diagram for explaining processing in step S63 of FIG. 4;

FIG. 6 is a flowchart diagram or explaining compression processing;

FIG. 7 is a diagram illustrating an example of a compression neural network;

FIG. 8 is a diagram illustrating a functional configuration example of a search circuit of a server;

FIG. 9 is a flowchart diagram for explaining search processing;

FIG. 10 is a flowchart diagram for explaining low-dimensional feature comparison processing;

FIG. 11 is a diagram illustrating a system configuration example according to a second embodiment;

FIG. 12 is a diagram illustrating a functional configuration example of a feature extraction circuit according to the second embodiment;

FIG. 13 is a flowchart diagram for explaining size calculation processing;

FIG. 14 is a diagram illustrating a functional configuration example of a search circuit of a server;

FIG. 15 is a diagram illustrating a data configuration example of a high-dimensional DB;

FIG. 16 is a diagram illustrating a data configuration example of a low-dimensional DB;

FIG. 17 is a diagram illustrating a data configuration example of a material DB; and

FIG. 18 is a diagram illustrating a data configuration example of a size DB.

### DESCRIPTION OF EMBODIMENTS

Hereinafter, embodiments will be described with reference to the drawings. When searching for a part by information processing, there are protrusions, recesses, and the like that may not be viewed from certain viewing angles, so that it is desirable to perform search using three-dimensional data related to parts. When searching for a part, the part is mainly searched for by using a shape similar to the part.

For example, a method is considered where attribute information such as part types and sizes labeled into shapes of each part is stored into a database and search is performed by using information labeled into a shape of a part to be searched for. In this method, a result of “shape is similar” is not obtained.

For this reason, a search method that considers similarity of shape is desired, and some approaches have been proposed. As an example, there is a method where points are arranged randomly (or from a plurality of fixed directions) on a surface of a three-dimensional shape and distances between the points are analyzed as a histogram. In this method, calculations are very complicated and a calculation cost is high, and further similarity is mechanically calculated, so that the similarity may be largely deviated from a “similar shape” in a human sense.

On the other hand, thanks to advance in artificial intelligence (AI) technology, a characteristic pattern (that is, a similar pattern) can be detected from a two-dimensional image. As an example, in the automobile industry, recognition of roads and traffic lanes and detection of pedestrians have reached a level where the recognition and the detection can be instantaneously performed by the artificial intelligence (AI) technology, and an autonomous driving technology may be established in the near future.

When there is a past product model similar to a part or an assembly to be designed, development man-hours can be reduced by replacing the part or the assembly with an existing part, improvement, or the like, as compared with a case where the part or the assembly is newly designed. Therefore, designers are very concerned with past product models similar to a part or an assembly to be designed.

A technique that “learns” a “similar shape” in a human sense by applying an image recognition technique by artificial intelligence to three-dimensional similar shape search is applied by the same applicant (U.S. patent application Ser. No. 15/474,304). Image recognition by artificial intelligence is realized by the disclosure. In the description below, the technique disclosed by the application is referred to as a disclosure α, and a descriptor creation device related to the disclosure α is referred to as a “search device using artificial intelligence” or simply a “search device”.

A phase is included where a human being teaches an artificial intelligence a feature pattern to be detected, so that it is possible to search for a “similar” shape close to a human sense. The search device using artificial intelligence includes the following two major elements.

### Major Element 1

An extraction circuit that extracts a feature vector from three-dimensional model and stores the feature vector in a database.

### Major Element 2

A search circuit to which a three-dimensional model is inputted and which searches for a shape most similar to the three-dimensional mode from a database. Details of the above <Major Element 1> and <Major Element 2> will be described later.

The search device using artificial intelligence can quickly and accurately search for a “similar” shape. However, when a large-scale three-dimensional model database is used, the search device becomes an expensive system in terms of both calculation cost and memory consumption.

A three-dimensional model is rendered from R visual line directions (hereinafter may be referred to as “R directions”). The R directions are obtained by rotating each of XYZ axes of the three-dimensional model by predetermined angles. The predetermined angles are, for example, 45 degrees, 90 degrees, and the like. When converting T features per visual line direction into a vector of a single precision floating-point number (four bytes), if storing S models into a database, a storage area used to store a matrix that represents the features is calculated by R×4T×S.

In other words, when S is several hundred thousand to several million, it is desirable to use a RAM (Random Access Memory) of 50 GB to several hundred GB. A floating-point number arithmetic instruction used for search exceeds one TFLOPs (Teraflops).

Memory consumption and search time may be reduced by reducing the number (R) of visual line directions or reducing a feature amount (T) per image. However, in this case, there is a problem that search accuracy is degraded. Although a search range may be reduced by dividing data and/or space, this is not efficient for a high dimensional feature space.

When specifying a part from an image rendered with a predetermined resolution and searching for a similar model, normally, the size of a part in the image is not taken into considerations. As an example, depending on images accumulated in a database, there is a problem that a very small screw used in an electronic device and a rivet used in an airplane are searched for as a similar shape. Further, while the shape of a part is normally calculated using geometry information obtained from an image, information such as material and type of part may not be obtained.

When searching for a purchased part that can be used, material and size of a part to be employed are important information to use the part. Therefore, it is desirable for a designer who uses a system that searches for a model of a similar shape to be able to obtain information of the material and size of a part to be employed at the same time. As an example, the presence or absence of conductivity is largely related to EMC (Electromagnetic Compatibility) such as electromagnetic non-interference, so that the material is important information when selecting a part.

Therefore, it is desirable to manage information such as the material for determining conductivity and the size in association with each other its a database in advance and indicate a plurality of similar shapes and their materials as a search result of parts of a similar shape. In this viewpoint, the inventors have performed studies below related to a search device using artificial intelligence.

A first idea is a method that adds additional information indicating material, size, and the like to a search device and calculates a similarity considering also the additional information. The method of the first idea is an application example that can be easily come up with by a system engineer.

Specifically, the search device according to the method of the first idea has a second neural network layer in addition to a first neural network layer. In the first neural network layer, a similarity of shape is calculated. In other words, feature vectors of T elements per direction are calculated in each of R directions. Further, in the second neural network layer, total similarity is calculated based on attributes such as material and size and the similarity of shape calculated in the first neural network layer. As another form of the first idea, material, size, and the like may be included in the feature vectors (T elements).

However, in the first idea, it is not possible to reduce calculation cost of similarity and memory consumption. In a case of the search device according to the method of the first idea, only when an output result can be specified by a total index (corresponding to the total similarity), it is possible to cause a network to learn. Therefore, it is desirable to prepare considerable learning models and associate them with each other by their total similarity. Thus, it can be said that the method of first idea is a method of less versatility.

A second idea is a method where screening is performed with a search condition before calculation of shape similarity is performed in a search device. According to the method of the second idea, although processing speed is improved because search targets are narrowed down to the search condition before the shape similarity is calculated, memory consumption may not be reduced. Further, when no search condition is given, calculation cost does not change.

As an example, a case s considered where when a designer wants to know whether or not there is data of a part having a similar shape in a database of a search device, the designer performs search using only shape without specifying a search condition. In this case, calculation cost and memory consumption may not be reduced.

A third idea is a method where an output result of a search device which a part having a similar shape is specified includes additional information such as material and size that are associated with each other in a database. The search device according to the third idea is a method that presents a plurality of similar shapes and additional information related to each shape to a designer and sorts them with attention attributes such as similarity, material, and size. Also in the third idea, processing speed and memory consumption may not be improved.

Through the studies described above, the inventors have found a method of reducing the memory consumption and the calculation cost while maintaining accuracy by comparing images in different resolutions. In short, the accuracy of the entire search is improved by narrowing down a search range having a small number of similar shapes with a small cast by using low dimensional feature vectors and subsequently performing highly accurate search using high dimensional feature vectors.

### First Embodiment

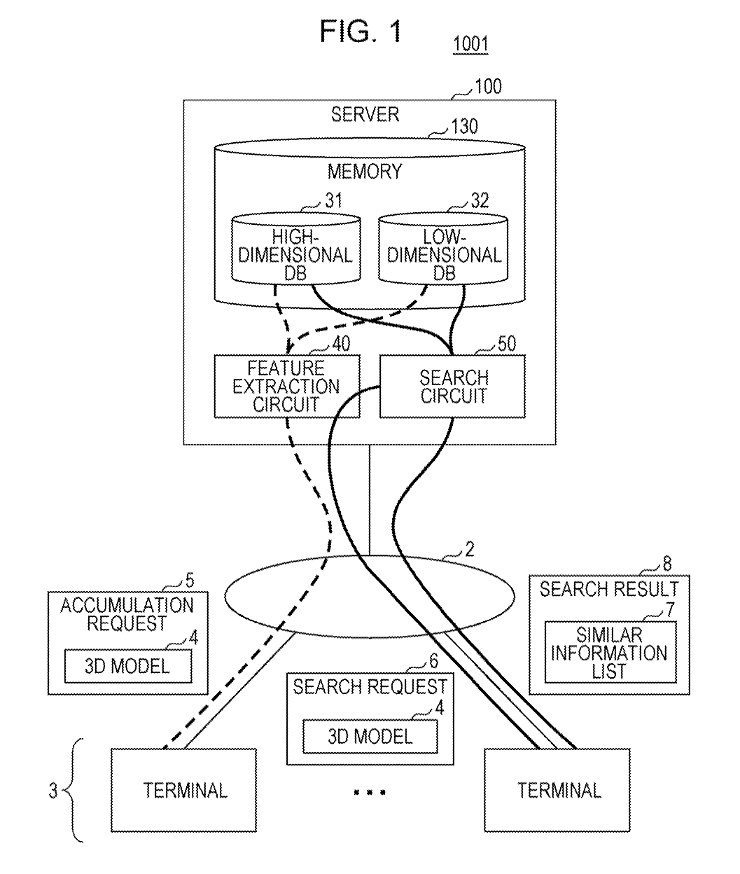

First, a system configuration example according to a first embodiment will be described. FIG. 1 is a diagram illustrating the system configuration example according to the first embodiment. A system 1001 illustrated in FIG. 1 has a server 100 and a plurality of terminals 3, and the server 100 and the plurality of terminals 3 are connected through a network 2.

The server 100 is an information processing device where the memory consumption and the calculation cost are improved in the search device using artificial intelligence described above. The server 100 has a feature extraction circuit 40 and a search circuit 50. A memory 130 of the server 100 stores a high-dimensional DB (Database) 31, a low-dimensional DB 32, and the like.

The feature extraction circuit 40 extracts a feature of a part from a 3D (three-dimensional) model 4, generates a high-dimensional feature vector indicating the extracted feature, and further generates a low-dimensional feature vector from the high-dimensional feature vector. When generating the high-dimensional feature vector and the low-dimensional feature vector, a neural network is used which has learned and acquired in advance a “similar shape” in a human sense.

The 3D model 4 is data that three-dimensionally represents a shape of a part. The 3D model 4 may be given to the server 100 by an accumulation request 5 from the terminal 3 through the network 2, or the high-dimensional DB 31 where a substantial amount of the 3D model 4 is accumulated may be prepared in the server 100. The 3D model 4 may be CAD (computer-aided design) data created by the terminal 3 or may be a 2D (two-dimensional) image where a subject is a part photographed from a plurality of directions.

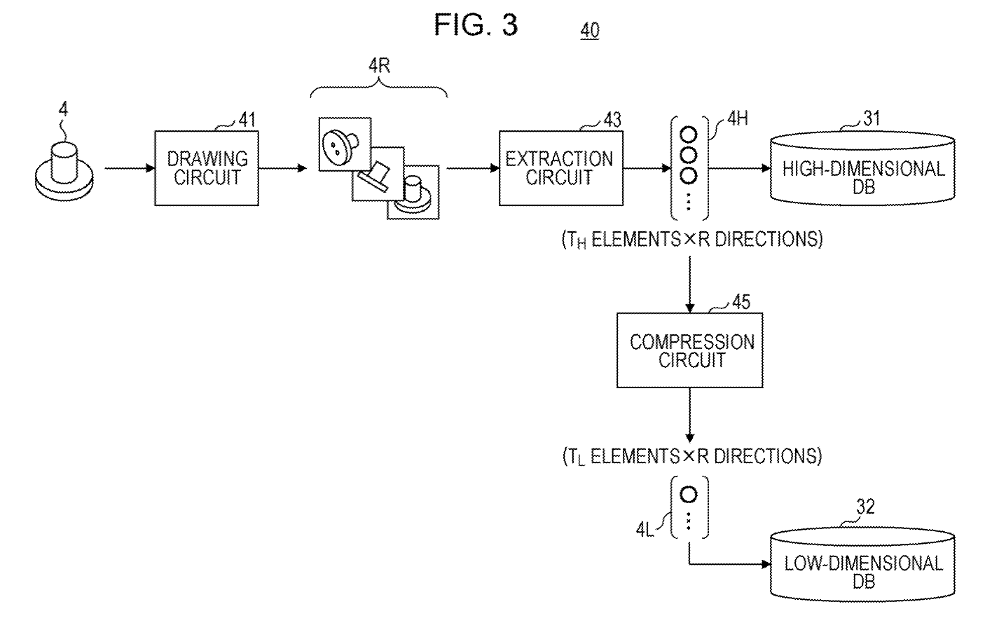

A high-dimensional feature vector 4H (FIG. 3) is accumulated in the high-dimensional DB 31 and a low-dimensional feature vector 4L (FIG. 3) is accumulated in the low-dimensional DB 32. When the server 100 receives a search request 6 from the terminal 3, the feature extraction circuit 40 acquires the high-dimensional feature vector 4H (FIG. 3) and the low-dimensional feature vector 4L (FIG. 3) from the 3D model 4 specified by the search request 6.

The search circuit 50 searches the low-dimensional DB 32 by using the low-dimensional feature vector 4L of the 3D model 4 of the search request 6, determines a search target of the high-dimensional feature vector 4H, and specifies a similar 3D model 4 by using the high-dimensional feature vector 4H of the 3D model 4 in the determined search target. A similar information list 7 where the specified 3D models 4 are listed is created and transmitted to the terminal 3 by being included in a search result 8.

The first embodiment is not limited to the configuration of the system 1001 described above. The terminal 3 used by a designer may be a single workstation mounted with functions of the server 100. In this case, it is possible to perform various processes by a single workstation without constructing a network.

In the first embodiment, similarity of the high-dimensional feature vector 4H is determined with respect to a search target narrowed down by the low-dimensional feature vector 4L, so that it is possible to reduce the memory consumption used for the processing as compared with a case where the entire high-dimensional DB 31 is used as a search target.

Each terminal 3 is a terminal used by a designer who is a user. Each terminal 3 accumulates 3D models 4 of a part formed into a product, a purchased part, and the like in the memory 130 of the server 100 and/or receives the search result 8 including the similar information list 7 by transmitting the search request 6 of a 3D model 4 of a part to be developed.

The similar information list 7 is displayed on the terminal 3, so that the designer can determine whether or not to develop a part. It is possible to shorten a product development process by using parts that have ever been developed or purchased.

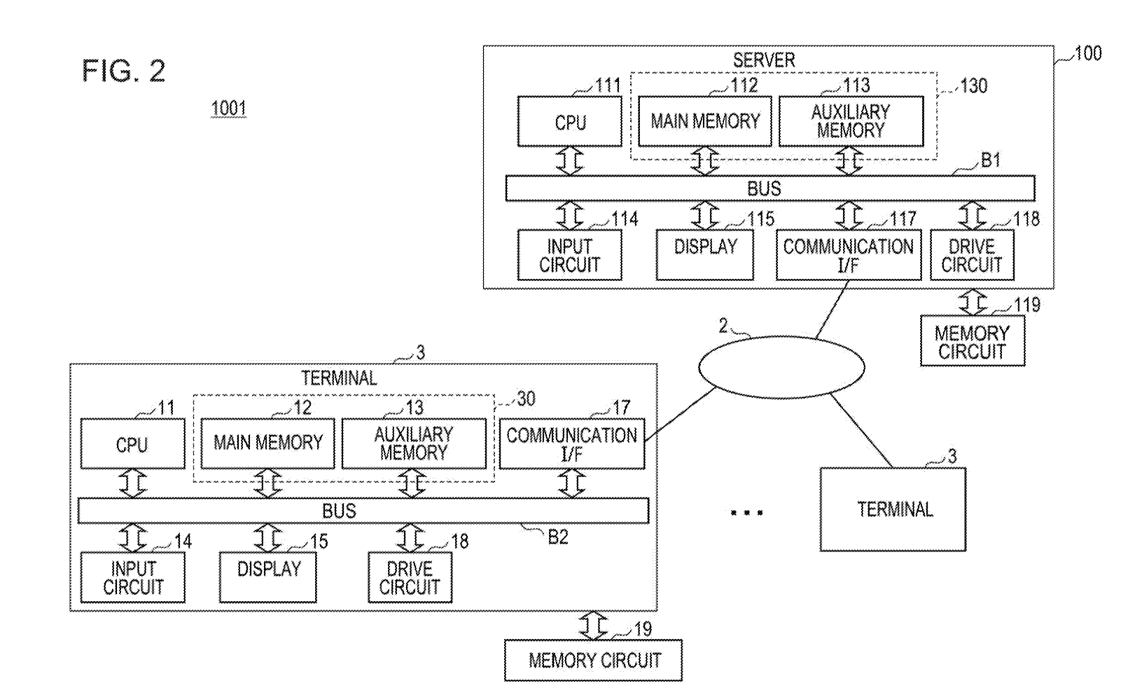

FIG. 2 is a diagram illustrating a hardware configuration. As illustrated in FIG. 2, the server 100 is an information processing device controlled by a computer and the server 100 has a CPU (Central Processing Unit) 111, a main memory 112, an auxiliary memory 113, an input device 114, a display device 115, a communication I/F (interface) 117, and a drive device 118, which are connected to a bus B1.

The CPU 111 corresponds to a processor that controls the server 100 according to a program stored in the main memory 112. A RAM (Random Access Memory), a ROM (Read Only Memory), and/or the like are used as the main memory 112. The main memory 112 stores or temporarily stores a program to be executed by the CPU 111, data used for processing of the CPU 111, data obtained by the processing of the CPU 111, and the like.

An HDD (Hard Disk Drive) or the like is used as the auxiliary memory 113, and data such as a program for performing various processes is stored in the auxiliary memory 113. A part of the program stored in the auxiliary memory 113 is loaded into the main memory 112 and executed by the CPU 111, so that various processes are realized. The main memory 112 and the auxiliary memory 113 correspond to the memory 130.

The input device 114 has a mouse, a keyboard, and the like, and is used by an administrator to input various information used for processing performed by the server 100. The display device 115 displays various information under control of the CPU 111. The input device 114 and the display device 115 may be an integrated user interface including a touch panel or the like. The communication I/F 117 performs communication through a network such as a wired network or a wireless network. The communication performed by the communication I/F 117 is not limited to wireless communication or wired communication.

The program that realizes processing performed by the server 100 is provided to the server 100 through a storage medium 119 such as, for example, a CD-ROM (Compact Disc Read-Only Memory).

The drive device 118 functions as an interface between the storage medium 119 (for example, a CD-ROM or the like) set in the drive device 118 and the server 100.

Further, a program that realizes various processes related to the present embodiment described later is stored in the storage medium 119, and the program stored in the storage medium 119 is installed in the server 100 through the drive device 118. The installed program can be executed by the server 100.

The storage medium 119 that stores the program is not limited to CD-ROM but may be one or more non-transitory tangible media having a computer readable structure. As a computer readable medium, in addition to, the CD-ROM, a portable recording medium such as a DVD disk and a USB memory, and a semiconductor memory such as a flash memory can be used.

The terminal 3 has a CPU 11, a main memory 12, an auxiliary memory 13, an input device 14, a display device 15, a communication I/F (interface) 17, and a drive device 18, which are connected to a bus B2.

The CPU 11 corresponds to a processor that controls the terminal 3 according to a program stored in the main memory 12. A RAM (Random Access Memory), a ROM (Read Only Memory), and/or the like are used as the main memory 12. The main memory 12 stores or temporarily stores a program to be executed by the CPU 11, data used for processing of the CPU 11, data obtained by the processing of the CPU 11, and the like.

An HDD (Hard Disk Drive) or the like is used as the auxiliary memory 13, and data such as a program for performing various processes is stored in the auxiliary memory 13. A part of the program stored in the auxiliary memory 13 is loaded into the main memory 12 and executed by the CPU 11, so that various processes are realized. The main memory 12 and the auxiliary memory 13 correspond to a memory 30.

The input device 14 has a mouse, a keyboard, and the like, and is used by an administrator to input various information used for processing performed by the terminal 3. The display device 15 displays various information under control of the CPU 11. The input device 14 and the display device 15 may be an integrated user interface including a touch panel or the like. The communication I/F 17 performs communication through a network such as a wired network or a wireless network. The communication performed by the communication I/F 17 is not limited to wireless communication or wired communication.

The program that realizes processing performed by the terminal 3 is provided to the terminal 3 through a storage medium 19 such as, for example, a CD-ROM (Compact Disc Read-Only Memory).

The drive device 18 functions as an interface between the storage medium 19 (for example, a CD-ROM or the like) set in the drive device 18 and the terminal 3.

Further, a program that realizes various processes related to the present embodiment described later is stored in the storage medium 19, and the program stored in the storage medium 19 is installed in the terminal 3 through the drive device 18. The installed program can be executed by the terminal 3.

The storage medium 19 that stores the program is not limited to CD-ROM but may be one or more non-transitory tangible media having a computer readable structure. As a computer readable medium, in addition to the CD-ROM, a portable recording medium such as a DVD disk and a USB memory, and a semiconductor memory such as a flash memory can be used.

FIG. 3 is a diagram illustrating a functional configuration example of a feature extraction circuit according to the first embodiment. In FIG. 3, the feature extraction circuit 40 has a drawing circuit 41, an extraction circuit 43, and a compression circuit 45. The drawing circuit 41 and the extraction circuit 43 respectively correspond to an image drawing circuit 11 and a feature vector extraction circuit 12 of the disclosure α. The extraction circuit 43 corresponds to <Major Element 1> of a search device of the disclosure α. The drawing circuit 41, the extraction circuit 43, and the compression circuit 45 are realized by processing which the program installed in the server 100 causes the CPU 111 of the server 100 to perform.

In the feature extraction circuit 40, when the 3D model 4 is inputted, an ID (corresponding to a part ID) is given to the 3D model 4, and the ID and the 3D model 4 are accumulated in a part DB (not illustrated in the drawings) and the like. For the 3D model 4, the drawing circuit 41 creates an R direction image set 4R including 2D images obtained by viewing a part from a plurality of directions (referred to as R directions).

The extraction circuit 43 extracts T_{H} elements from the 2D image for each direction by using the R direction image set 4R created by the drawing circuit 41 and creates the high-dimensional feature vector 4H.

The extraction circuit 43 corresponds to a feature extraction neural network that extracts T_{H} elements from an image and acquires the high-dimensional feature vector 4H by using the feature extraction neural network. The high-dimensional feature vector 4H is stored in the high-dimensional DB 31 along with the ID given to the 3D model 4. Further, the ID of the 3D model 4 and the high-dimensional feature vector 4H are inputted into the compression circuit 45.

Then, the compression circuit 45 converts the high-dimensional feature vector 4H into the low-dimensional feature vector 4L. The obtained low-dimensional feature vector 4L is stored in the low-dimensional DB 32 along with the ID of the 3D model 4.

When the feature extraction circuit 40 receives the accumulation request 5 or the search request 6, the feature extraction circuit 40 performs the feature extraction processing described above. When the feature extraction circuit 40 receives the search request 6, the accumulation of the high-dimensional feature vector 4H and the low-dimensional feature vector 4L is omitted.

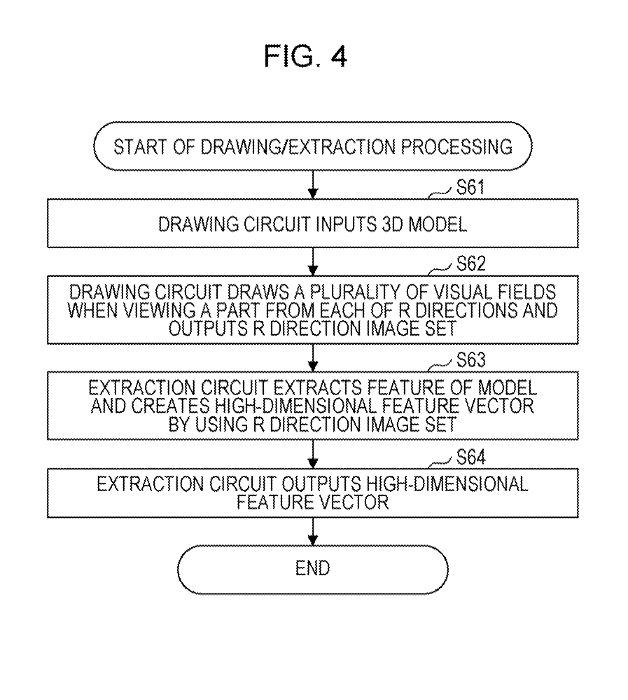

Drawing/extraction processing performed by the drawing circuit 41 and the extraction circuit 43 will be described. FIG. 4 is a flowchart diagram for explaining the drawing/extraction processing. As illustrated in FIG. 4, in the drawing/extraction processing, the drawing circuit 41 inputs 3D model 4 (step S61) and draws a plurality of visual fields when viewing a part from each of R directions and outputs the R direction image set 4R to the memory 130 (step S62).

Then, the extraction circuit 43 extracts the feature of the model and creates the high-dimensional feature vector 4H by using the R direction mage set 4R generated by the drawing circuit 41 stored in the memory 130 (step S63). The high-dimensional feature vector 4H is created for all visual field directions. The extraction circuit 43 outputs the high-dimensional feature vector 4H to the memory 130 (step S64). Then, the drawing/extraction processing is completed.

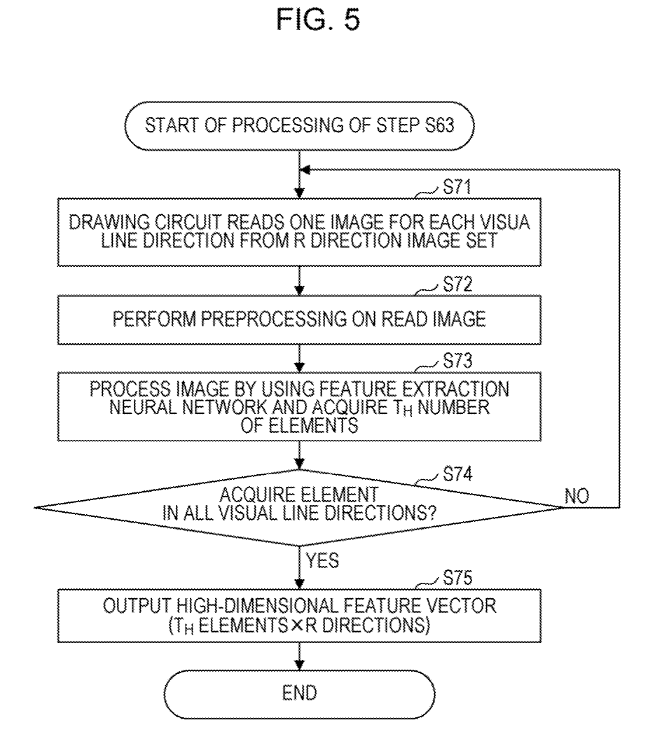

Processing where the extraction circuit 43 extracts the high-dimensional feature vector 4H in step S63 described above will be described in detail. FIG. 5 is a flowchart diagram for explaining the processing in step S63 of FIG. 4. In FIG. 5, the drawing circuit 41 reads one image for each visual line direction from the R direction image set 4R stored in the memory 130 (step S71) and performs preprocessing on the read image (step S72). An image is read for each direction.

The drawing circuit 41 processes an image by using the feature extraction neural network and acquires T_{H} number of elements (step S73). Then, the drawing circuit 41 determines whether or not an element is acquired in all the visual line directions (step S74). When an element is acquired not in all the visual line directions (NO in step S74), the drawing circuit 41 returns to step S71, reads an image in the next visual line direction, and performs the same processing as described above.

On the other hand, when an element is acquired in all the visual line directions (YES in step S74), the drawing circuit 41 outputs the high-dimensional feature vector 4H (T_{H} elements×R directions) to the memory 130 (step S75). The high-dimensional feature vector 4H is held in the high-dimensional DB 31 of the memory 130. Then, the processing of step S63 is completed.

Next, compression processing performed by the compression circuit 45 will be described. The compression circuit 45 corresponds to a neural network which has learned and obtained a “similar shape” in a human sense. The neural network of the compression circuit 45 is a network where the number of neurons of the neural network of the extraction circuit 43 is reduced. Hereinafter, the neural network of the compression circuit 45 is referred to as a “compression neural network”.

As the feature extraction neural network and the compression neural network, it is possible to use AlexNet (Krizhevsky, Alex, Ilya Sutskever and Geoffrey E. Hinton, “Advances in neural information processing system, 2012) and GoogLeNet (Szegedy, Christian, et al, “Going deeper with convolutions” Proceedings Of the IEEE Conference on Computer Vision and Pattern Recognition, 2015). However, the neural networks are not limited to the above, but other neural networks may be used.

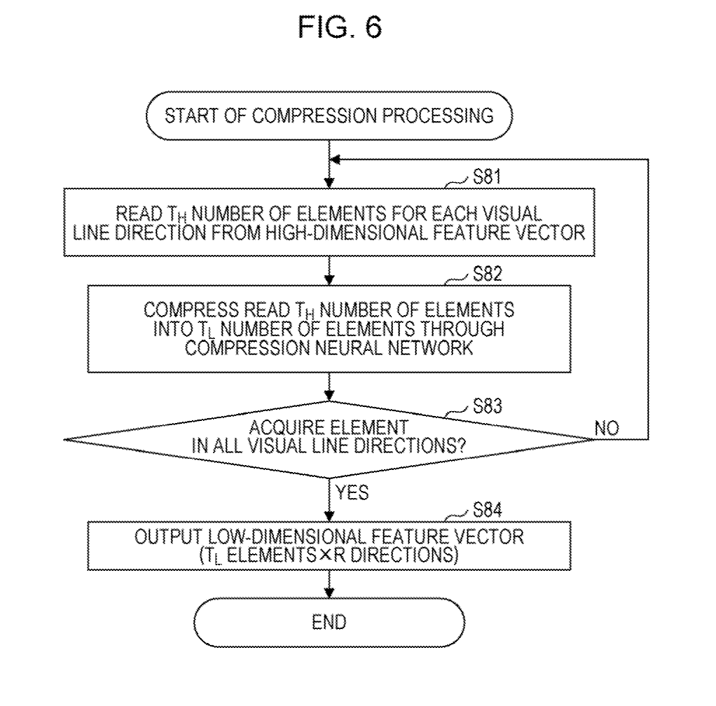

FIG. 6 is a flowchart diagram for explaining the compression processing. In FIG. 6, the compression circuit 45 reads T_{H} elements for each visual line direction from the high-dimensional feature vector 4H stored in the memory 130 (step S81).

The compression circuit 45 compresses the read T_{H} elements into T_{L} elements through the compression neural network (step S82). When obtaining the T_{L} elements, the compression circuit 45 determines whether or not an element is acquired in all the visual line directions (step S83). When an element is acquired not in all the visual line directions (NO in step S83), the compression circuit 45 proceeds to step S81, acquires T_{H} elements in the next visual line direction, and repeats the same processing as described above.

On the other hand, when an element is acquired in all the visual line directions (YES in step S83), the compression circuit 45 outputs the low-dimensional feature vector 4L (T_{L} elements×R directions) to the memory 130 (step S84). Then, the compression circuit 45 completes the compression processing. By the compression processing, it is possible to obtain the low-dimensional feature vector 4L having T_{L} elements, the number of which is smaller than T_{H}, in each visual line direction. The obtained low-dimensional feature vector 4L is held in the low-dimensional DB 32 of the memory 130.

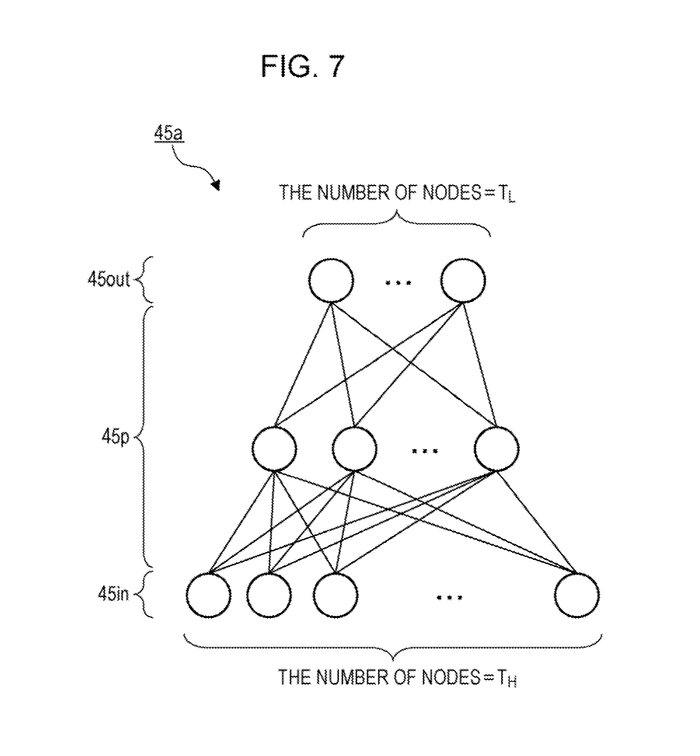

FIG. 7 is a diagram illustrating an example of the compression neural network. In FIG. 7, a compression neural network 45a has an input layer 45in, an artificial intelligence layer 45p, and an output layer 45out.

The input layer 45in has nodes, the number of which is the number of elements T_{H} of the high-dimensional feature vector 4H, and values of each element are inputted into the input layer 45in. The artificial intelligence layer 45p has a weight parameter obtained by learning the “similar shape” in a human sense in advance and performs processing for weighting an inputted value of node. The input layer 45out has nodes, the number of which is the number of elements T_{L} of the low-dimensional feature vector 4L, and outputs a result of calculation performed by using a value after being weighted, which is inputted from the artificial intelligence layer 45p.

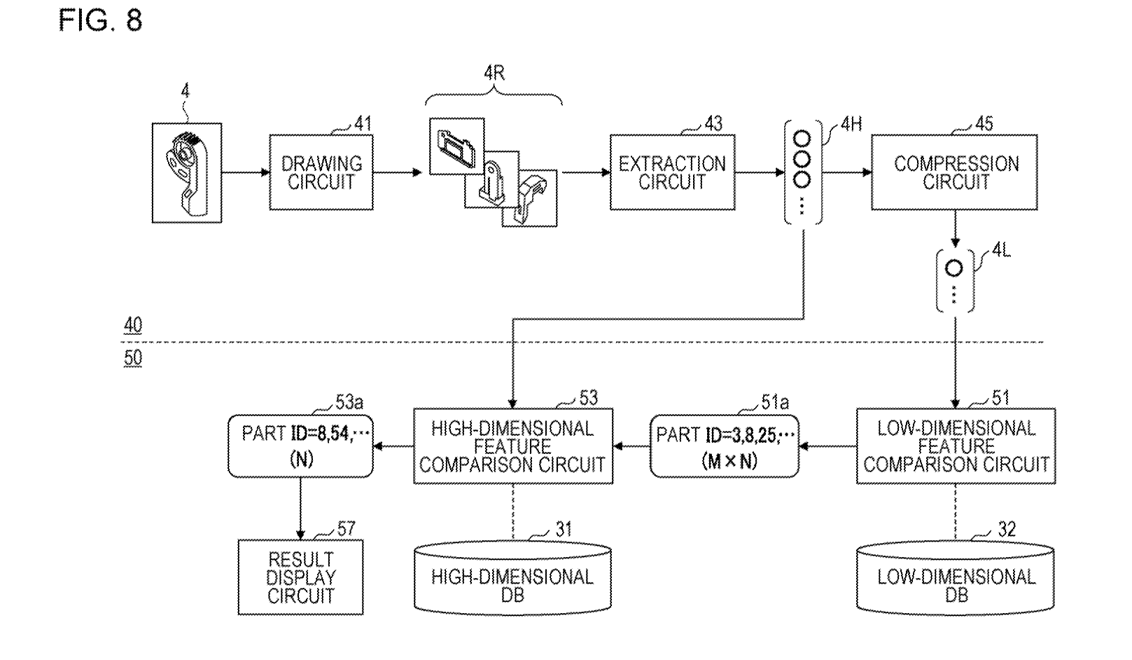

FIG. 8 is a diagram illustrating a functional configuration example of a search circuit of a server. In FIG. 8, according to the search request 6 from the terminal 3, search processing is performed by the search circuit 50 after the feature extraction processing performed by the feature extraction circuit 40, so that a functional configuration of the feature extraction circuit 40 is also illustrated.

When the search is performed, although a feature of the 3D model 4 included in the search request 6 is extracted, the high-dimensional feature vector 4H and the low-dimensional feature vector 4L are not accumulated in the high-dimensional DB 31 and the low-dimensional DB 32, and the high-dimensional feature vector 4H and the low-dimensional feature vector 4L are temporarily stored in the memory 130.

The search circuit 50 has a low-dimensional feature comparison circuit 51, a high-dimensional feature comparison circuit 53, and a result display circuit 57. The low-dimensional feature comparison circuit 51, the high-dimensional feature comparison circuit 53, and the result display circuit 57 are realized by processing which a program installed in the server 100 causes the CPU 111 of the server 100 to perform.

The low-dimensional feature comparison circuit 51 reads the low-dimensional DB 32, acquires the low-dimensional feature vector 4L of the 3D model 4 of the search request 6 that is temporarily stored from the memory 130, and compares the acquired low-dimensional feature vector 4L with all the low-dimensional feature vectors 4L in the low-dimensional DB 32. Similarity may be determined by an inner product between the low-dimensional feature vectors 4L.

A low-dimensional feature comparison result 51a is created by acquiring IDs associated with the low-dimensional feature vectors 4L from the low-dimensional DB 32 in order from the most similar low-dimensional feature vector 4L. It is desirable to extract IDs, the number of which is greater than N that is set by a designer, so that M×N IDs are extracted.

Here, M is a data-dependent factor and may be an integer greater than or equal to 2. Specifically, when M is 5 for a request for searching for N (=10) most similar shapes, the low-dimensional feature comparison circuit 51 specifies 50 models in the descending order of similarity. In the low-dimensional feature comparison result 51a, 50 IDs are indicated. The low-dimensional feature comparison result 51a is temporarily stored in the memory 130.

The high-dimensional feature comparison circuit 53 reads the high-dimensional DB 31 and acquires the high-dimensional feature vectors 4H of the IDs indicated by the low-dimensional feature comparison result 51a in the memory 130 from the high-dimensional DB 31. The high-dimensional feature comparison circuit 53 compares the high-dimensional feature vector 4H of the 3D model 4 of the search request 6 from the memory 130 with the high-dimensional feature vectors 4H acquired from the high-dimensional DB 31. Similarity between the high-dimensional feature vectors 4H may be determined by an inner product.

The high-dimensional feature comparison circuit 53 selects N IDs in the descending order of similarity and creates a similar shape result 53a indicating the selected IDs. IDs of candidate images are indicated by the similar shape result 53a.

The result display circuit 57 creates the similar information list 7 by acquiring part information from a part DB associated with the IDs of the created similar shape result 53a and transmits the search result 8 including the created similar information list 7 to the terminal 3 that is a search request source, so that the result display circuit 57 causes the terminal 3 to display the similar information list 7.

In the above description, a case where N models most similar to the inputted 3D model 4 are searched for is described as an example. However, a plurality of models whose distance (similarity) is smaller than or equal to a predetermined threshold value may be searched for.

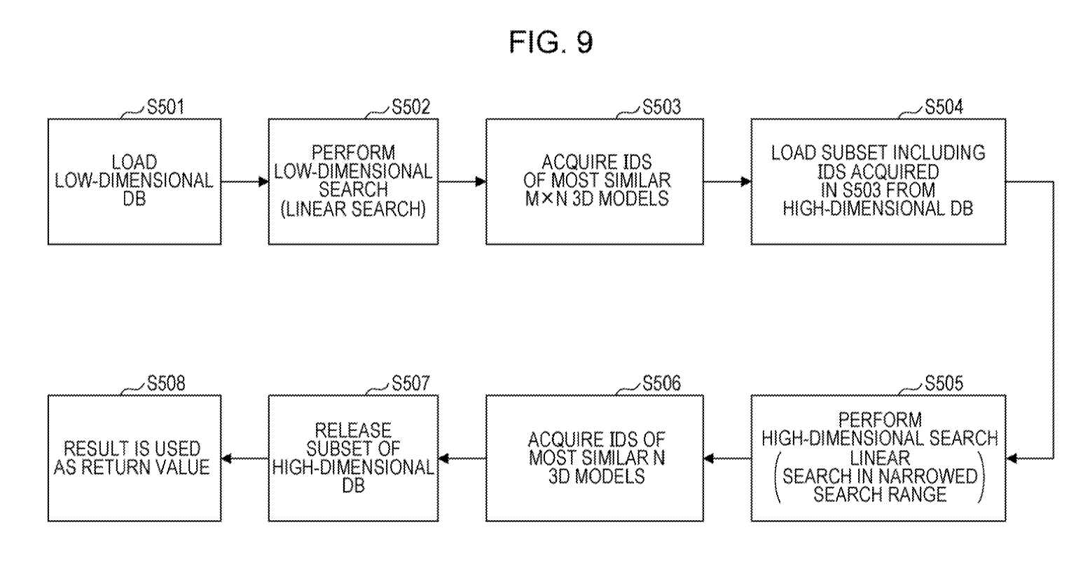

Next, the search processing performed by the search circuit 50 will be described. FIG. 9 is a flowchart diagram for explaining the search processing. In FIG. 9, in the search circuit 50, the low-dimensional feature comparison circuit 51 loads the to DB 32 (step S501) and performs a low-dimensional search (step S502). The low-dimensional search corresponds to a linear search and is performed on all IDs in the low-dimensional DB 32.

The low-dimensional feature comparison circuit 51 acquires IDs of most similar M×N 3D models 4 based on a result of the low-dimensional search (step S503). The low-dimensional feature comparison result 51a indicating the IDs of M×N 3D models 4 is stored in the memory 130.

Next, the high-dimensional feature comparison circuit 53 refers to the low-dimensional feature comparison result 51a, loads a subset including the IDs acquired in step S503 from the high-dimensional DB 31 (step S504), and performs a high-dimensional search (step S505). In this case, a search range is narrowed down by the IDs acquired in step S503, so that it is possible to largely reduce the amount of memory consumed by the loaded subset.

The high-dimensional feature comparison circuit 53 acquires IDs of most similar N 3D models 4 (step S506) and releases the subset of the high-dimensional DB 31 (step S507). Then, the high-dimensional feature comparison circuit 53 outputs the similar shape result 53a indicating the acquired IDs of N 3D models 4 as a return value (step S508).

The low-dimensional search in step S503 has a feature to reduce memory consumption for storing a matrix for similarity calculation and be able to screen candidates of a similar shape, which are a calculation result, while reducing a calculation speed of the similarity calculation, because the number of dimensions is smaller than that of the high-dimensional search.

The high-dimensional search in step S505 is performed on a very small subset of IDs, so that only a small amount of resource is used.

M has to be simply M>1. However, it is preferable that the value of M and the number of neurons of the compression circuit 45 have a magnitude where the most similar shapes calculated in the high-dimensional search can be guaranteed to be included in a subset of IDs outputted by the low-dimensional search. Generally, the smaller the number of neurons of the compression circuit 45, the greater the value of M.

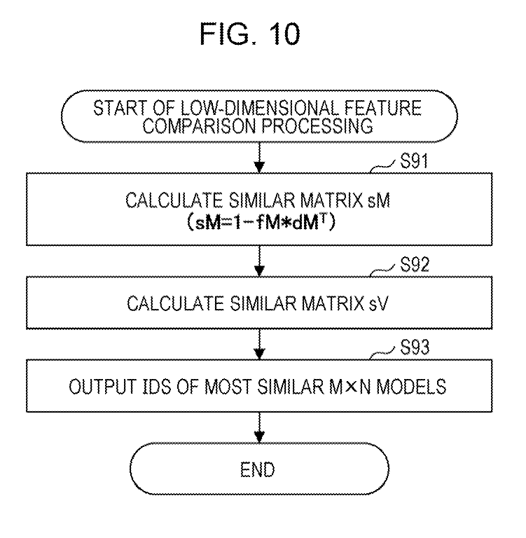

Next, the low-dimensional feature comparison circuit 51 of the search circuit 50 corresponds to <Major Element 2> of the disclosure α. Low-dimensional feature comparison processing performed by the low-dimensional feature comparison circuit 51 will be described. FIG. 10 is a flowchart diagram for explaining the low-dimensional feature comparison processing.

In FIG. 10, the low-dimensional feature comparison circuit 51 calculates a similar matrix sM (step S91). The similar matrix sM is represented by the following formula.

sM=1−fM*dM^{T} (1)

In the above formula (1), fM represents a feature matrix and dM represents a database matrix. The sign “*” represents a multiplication of matrix and the superscript T represents a transposed matrix. In the formula (1), it is premised that a feature vector is normalized.

In the feature matrix fM, a row specifies a visual line direction and a column specifies an element (feature). One column indicates a feature vector of an image when a part is seen from a certain visual line direction. The feature matrix fM is a matrix that represents all feature vectors in different visual line directions by a plurality of columns.

The database matrix dM is a matrix of all IDs managed in the low-dimensional DB 32 and the feature matrix fM. The size of the database matrix dM is represented by a total number of IDs and lengths of feature vectors.

Next, the low-dimensional feature comparison circuit 51 calculates a similar vector sV (step S92). In the similar vector sV, a total number of IDs is defined as a length, and a jth element represents a distance between the 3D model 4 of the search request 6 and a jth model.

Processing of obtaining a minimum cosine distance between a feature vector of an image in an ith visual line direction of the 3D model 4 of the search request 6 and a feature vector of each of images in all the visual line directions of the jth model is performed on images in all the visual line directions of the 3D model 4 of the search request 6. It is represented that the smaller the distance, the more similar. All the obtained minimum cosine distances are summed up. The summed up value is represented by the jth element.

The low-dimensional feature comparison circuit 51 acquires M×N IDs specified by a designer in order from the most similar model based on the similar vector sV (step S93). The similar shape result 53a indicating M×N IDs is outputted to the memory 130, and the low-dimensional feature comparison processing performed by the low-dimensional feature comparison circuit 51 is completed.

High-dimensional feature comparison processing performed by the high-dimensional feature comparison circuit 54 is substantially the same as the low-dimensional feature comparison processing performed by the low-dimensional feature comparison circuit 51. In the high-dimensional feature comparison processing, the database matrix dM may be defined for the IDs of M×N 3D models 4 acquired in step S93, and IDs of N 3D models 4 may be acquired based on the similar vector sV.

As described above, in the first embodiment, the feature extraction of the 3D model 4 to be searched for is performed in high dimensions and low dimensions, so that it is possible to reduce the memory consumption and the number of execution times when the search is performed.

Further, in the feature extraction, a neuron network that has learned a similar shape in a human sense is used, so that it is possible to accurately specify a model of a part having a similar shape.

### Second Embodiment

Next, a second embodiment that outputs the search result 8 including additional information such as size and material will be described. In the second embodiment, a model having a similar shape is searched for in three-dimensional CAD data 4b that represents a part shape created by CAD in three dimensions, so that a model having a similar shape is accurately searched for by using additional information included in the three-dimensional CAD data 4b.

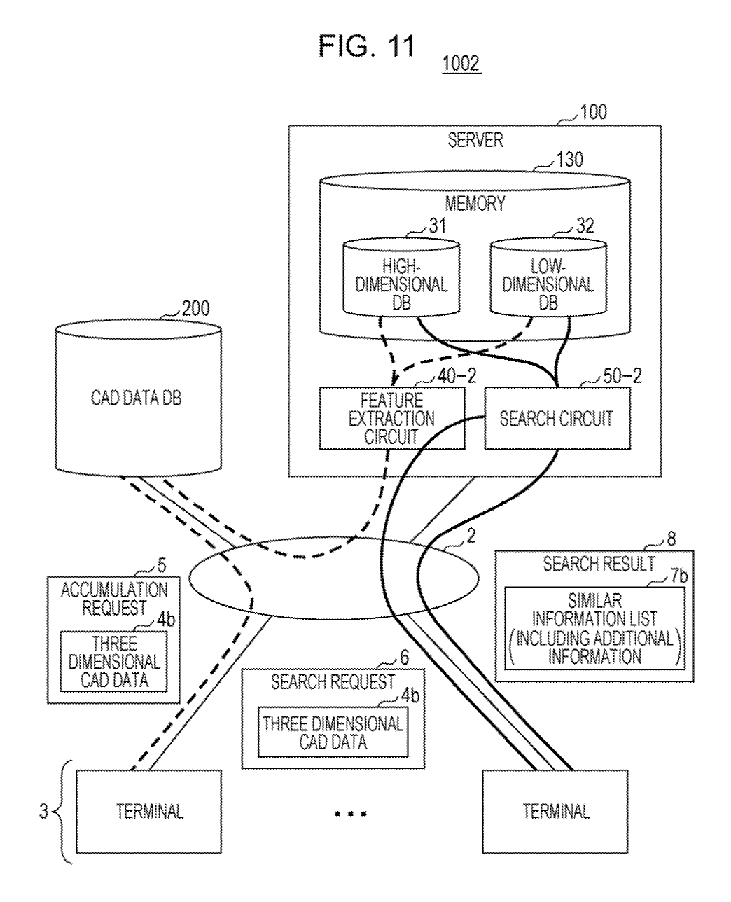

FIG. 11 is a diagram illustrating a system configuration example according to the second embodiment. A system 1002 illustrated in FIG. 11 has a server 100 and a plurality of terminals 3, and the server 100, the plurality of terminals 3, and a CAD data DB 200 are connected through the network 2.

The server 100 is substantially the same information processing device as that of the first embodiment and has a feature extraction circuit 40-2 and a search circuit 50b. In the same manner as in the first embodiment, a memory 130 of the server 100 sores a high-dimensional DB (DataBase) 31, a low-dimensional DB 32 and the like.

A difference from the first embodiment is that the accumulation request 5 from the terminal 3 is issued to the CAD data DB 200. According to addition of the three-dimensional CAD data 4b to the CAD data DB 200, the high-dimensional feature vector 4H and the low-dimensional feature vector 4L are created by the feature extraction circuit 40-2 of the server 100, and the high-dimensional feature vector 4H and the low-dimensional feature vector 4L are stored in the high-dimensional DB 31 and the low-dimensional DB 32, respectively.

In the second embodiment, further, the feature extraction circuit 40-2 acquires additional information from the three-dimensional CAD data 4b and stores the acquired additional information into the memory 130 in association with an ID.

The accumulation request 5 may be transmitted from the CAD data DB 200 to the server 100 or the server 100 may request newly accumulated three-dimensional CAD data 4b from the CAD data DB 200. The three-dimensional CAD data 4b is data including information that is created by CAD or the like and can represent a part shape on a virtual space. The three-dimensional CAD data 4b indicates parameters and the like that represent a vertex value, a position, and a shape.

In the second embodiment, a designer does not have to be conscious of accumulating the three-dimensional CAD data 4b to the server 100. The designer may design a part by CAD on the terminal 3 or the like and store the design into the CAD data DB 200.

In the server 100, for the search request 6 from the terminal 3, the search circuit 50b acquires additional information associated with an ID for each ID of a model having a similar shape obtained by processing in the first embodiment, and provides a search result 7b including the additional information to the terminal.

In the search result 8 in the second embodiment, a similar information list 7b including the additional information is provided to the terminal 3 and is displayed on the display device 15, so that the designer can obtain not only similarity of shape but also size and material from the additional information.

The hardware configurations of the server 100 and the terminal 3 are the same as those of the first embodiment, so that their descriptions will be omitted.

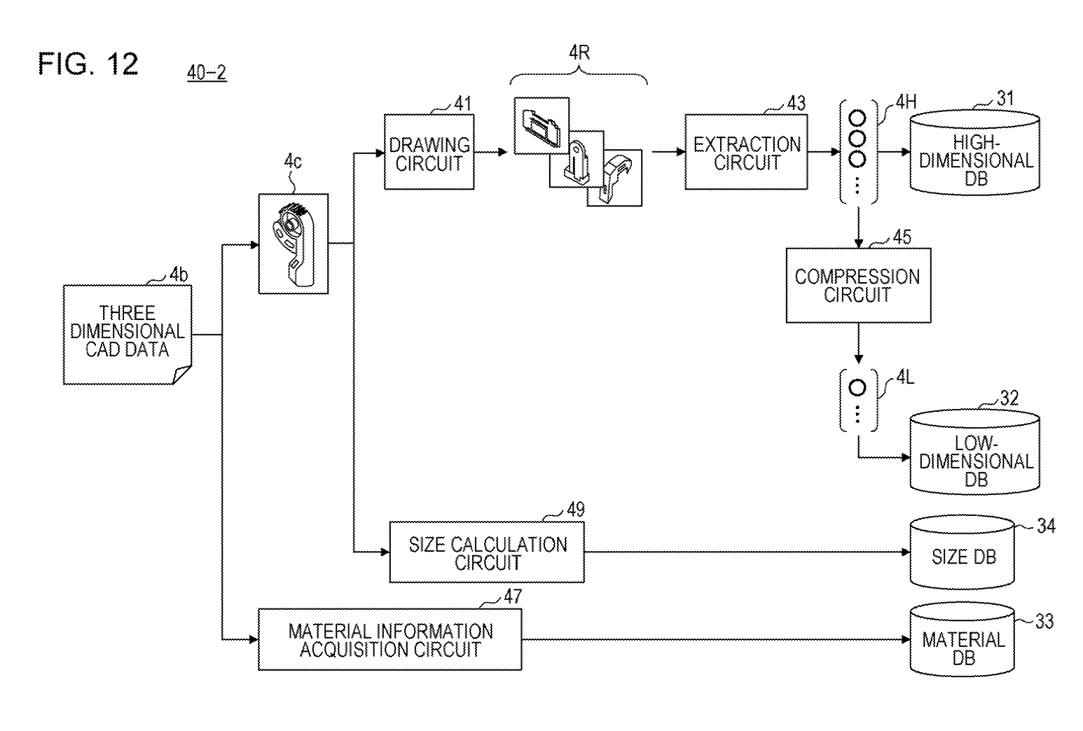

FIG. 12 is a diagram illustrating a functional configuration example of the feature extraction circuit according to the second embodiment. In FIG. 12, the feature extraction circuit 40-2 further includes a material information acquisition circuit 47 and a size calculation circuit 49 in addition to the drawing circuit 41, the extraction circuit 43, and the compression circuit 45 in the first embodiment.

The drawing circuit 41, the extraction circuit 43, the compression circuit 45, the material information acquisition circuit 47, and the size calculation circuit 49 are realized by processing which the program installed in the server 100 causes the CPU 111 of the server 100 to perform.

The feature extraction circuit 40-2 acquires shape data 4c from the three-dimensional CAD data 4b and inputs the shape data 4c into the drawing circuit 41. The processing operations performed respectively by the drawing circuit 41, the extraction circuit 43, and the compression circuit 45 are the same as those in the first embodiment, so that the descriptions thereof will be omitted.

On the other hand, the material information acquisition circuit 47 of the feature extraction circuit 40-2 acquires material information from the three-dimensional CAD data 4b and adds the material information to a material DB 33 along with an ID. Further, the size calculation circuit 49 acquires vertex coordinates and the like from the shape data 4c, calculates the size of part, and adds the size to a size DB 34. Size calculation processing performed by the size calculation circuit 49 will be described.

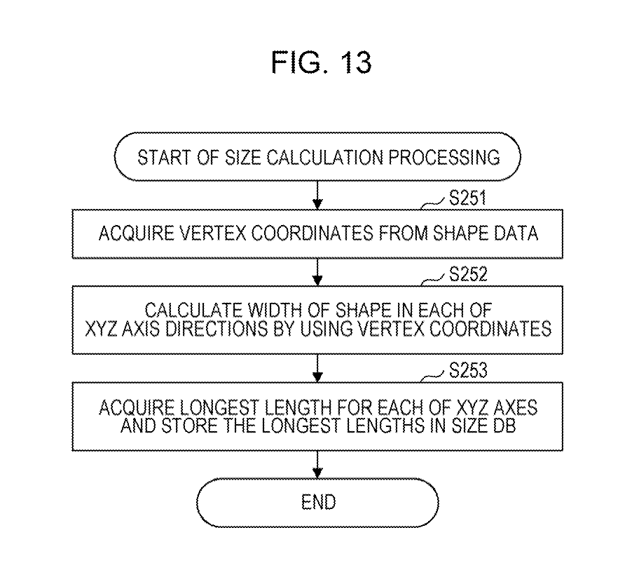

FIG. 13 is a flowchart diagram for explaining the size calculation processing. In FIG. 13, the size calculation circuit 49 acquires the vertex coordinates from the shape data 4c (step S251) and calculates widths in each of XYZ axis directions by using the acquired vertex coordinates (step S252).

The size calculation circuit 49 acquires a longest length for each of XYZ axes, stores the longest lengths in the size DB 34 (step S253), and ends the size calculation processing.

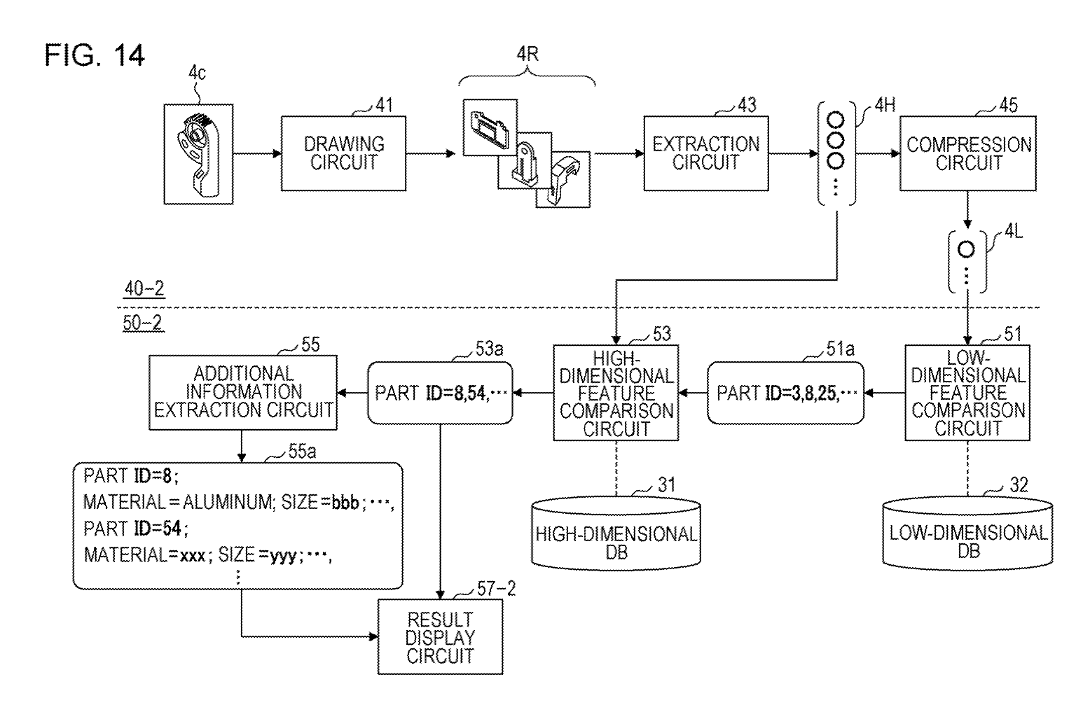

FIG. 14 is a diagram illustrating a functional configuration example of the search circuit of the server. In FIG. 14, according to the search request 6 from the terminal 3, search processing is performed by a search circuit 50-2 after the feature extraction processing performed by the feature extraction circuit 40-2, so that a functional configuration of the feature extraction circuit 40-2 is also illustrated.

When the search is performed, although a feature of the shape data 4c included in the search request 6 is extracted, the high-dimensional feature vector 4H and the low-dimensional feature vector 4L are not accumulated in the high-dimensional DB 31 and the low-dimensional DB 32, and the high-dimensional feature vector 4H and the low-dimensional feature vector 4L are temporarily stored in the memory 130.

The search circuit 50-2 has the low-dimensional feature comparison circuit 51 and the high-dimensional feature comparison circuit 53 in the same manner as in the first embodiment, so that the description thereof will be omitted. In the second embodiment, the search circuit 50-2 further includes an additional information extraction circuit 55 and a result display circuit 57-2. The low-dimensional feature comparison circuit 51, the high-dimensional feature comparison circuit 53, the additional information extraction circuit 55, and the result display circuit 57-2 are realized by processing which a program installed in the server 100 causes the CPU 111 of the server 100 to perform.

In the same manner as in the first embodiment, the low-dimensional feature comparison circuit 51 compares the low-dimensional feature vector 4L with all the low-dimensional feature vectors 4L in the low-dimensional DB 32 and obtains the low-dimensional feature comparison result 51a. The comparison may be performed by using an inner product. M×N candidate models having a similar shape in a human sense are indicated by IDs of the low-dimensional feature comparison result 51a.

The high-dimensional feature comparison circuit 53 compares the high-dimensional feature vector 4H with the high-dimensional feature vectors 4H acquired from the high-dimensional DB 31 based on the low-dimensional feature comparison result 51a and obtains the similar shape result 53a. Not all data of the high-dimensional DB 31 is used, but M×N candidate models specified by the ow-dimensional feature comparison result 51a are used. The comparison may be performed by using an inner product. In the similar shape result 53a, N candidate models are specified by IDs.

In the second embodiment, further, the additional information extraction circuit 55 searches the material DB 33 and the size DB 34 by using IDs indicated by the similar shape result 53a obtained by the high-dimensional feature comparison circuit 53 and acquires material and size from the material DB 33 and the size DB 34, respectively. An extraction result 55a where material and size are indicated in association with each ID indicated by the similar shape result 53a is outputted.

The result display circuit 57-2 creates the similar information list 7b including the additional information by using the similar shape result 53a and the extraction result 55a and transmits the search result 8 including the similar information list 7b to the terminal 3 that is a request source of the search request 6. The result display circuit 57-2 is the same as the result display circuit 57 of the first embodiment except that the result display circuit 57-2 uses the extraction result 55a in addition to the similar shape result 53a.

As described above, in the second embodiment, the feature extraction is automatically performed and the high-dimensional DB 31 and the low-dimensional DB 32 are updated every time new three-dimensional CAD data 4b is added by cooperation with the CAD data DB 200.

Further, when searching the three-dimensional CAD data 4b, in the same manner as in the first embodiment, the memory consumption and the number of execution times are reduced. Further, in the second embodiment, it is possible to present additional information such as size and material for candidate models having a similar shape in a human sense to a designer, so that the designer can more reliably verify the presence or absence of a desired part.

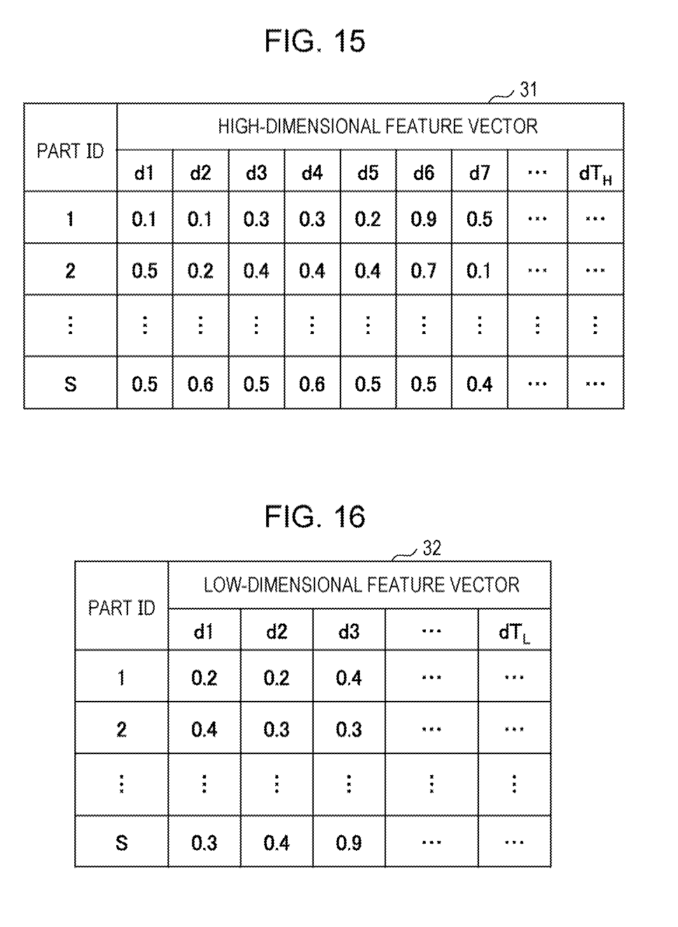

Next, various databases used in the first embodiment and the second embodiment will be described. FIG. 15 is a diagram illustrating a data configuration example of the high-dimensional DB. In FIG. 15, the high-dimensional DB 31 is a database that stores the high-dimensional feature vector 4H for each model that represents a part and the high-dimensional DB 31 has items such as a part ID and a high-dimensional feature vector.

The part ID is an ID that specifies a model. The high-dimensional feature vector indicates a value of each of T_{H} elements of the high-dimensional feature vector 4H calculated by the extraction circuit 43.

In this example, the high-dimensional feature vector 4H of a part ID “1” is (0.1, 0.1, 0.3, 0.3, 0.2, 0.9, 0.5, . . . ) and the high-dimensional feature vector 4H of a part ID “2” is (0.5, 0.2, 0.4, 0.4, 0.4, 0.7, 0.4, . . . ). For the other part IDs, in the same manner, T_{H} values of the high-dimensional feature vector 4H are indicated.

FIG. 16 is a diagram illustrating a data configuration example of the low-dimensional DB. In FIG. 16, the low-dimensional DB 32 is a database that stores the low-dimensional feature vector 4L for each model that represents a part and the low-dimensional DB 32 has items such as a part ID and a low-dimensional feature vector.

The part ID is an ID that specifies a model. The low-dimensional feature vector indicates a value of each of T_{L} elements of the low-dimensional feature vector 4L calculated by the extraction circuit 43. Here, T_{L}<T_{H}.

In this example, the low-dimensional feature vector 4L of a part ID “1” is (0.2, 0.2, 0.4, . . . ) and the low-dimensional feature vector 4L of a part ID “2” is (0.4, 0.3, 0.3, . . . ). For the other part IDs, in the same manner, T_{L} values of the low-dimensional feature vector 4L are indicated.

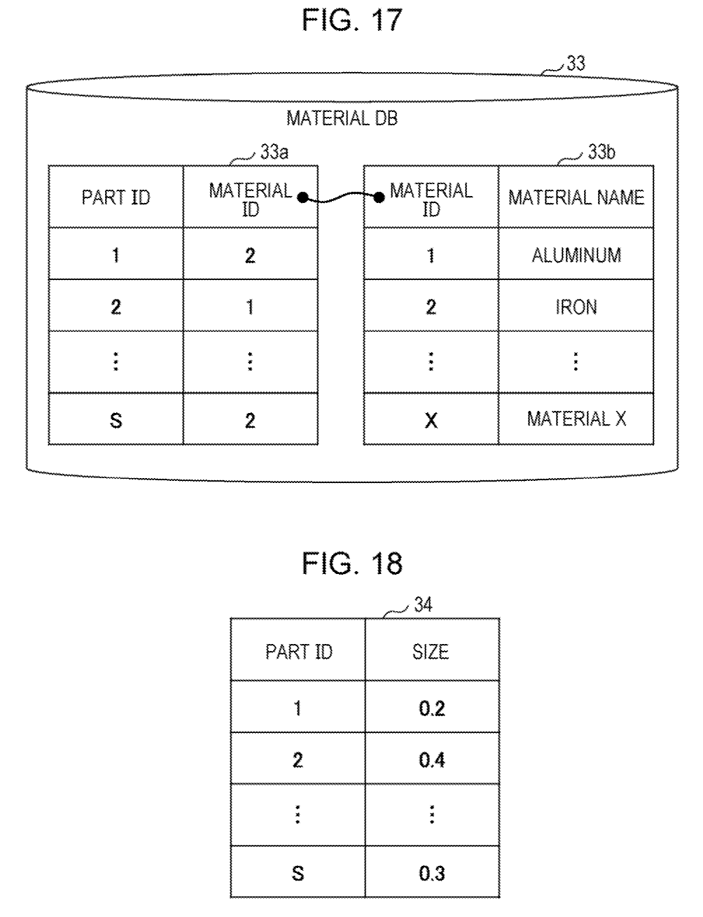

In the second embodiment, the material DB 33 and the size DB 34 are further used. FIG. 17 is a diagram illustrating a data configuration example of the material DB. In FIG. 17, the material DB 33 is a database for storing and managing a material name of a model representing a part, and the material DB 33 has a first table 33a and a second table 33b.

The first table 33a is a table where the part ID and a material ID are associated with each other. The second table 33b is a table where the material ID and a material name are associated with each other. The first table 33a and the second table 33b are associated by the material ID, so that the part ID can be associated with the material name.

FIG. 18 is a diagram illustrating a data configuration example of the size DB. In FIG. 18, the size DB 34 is a database that stores a size for each model, and the size DB 34 has items such as a part ID and a size. The part ID is an ID that specifies a model. The size indicates a longest length among widths in each of XYZ axis directions obtained from the shape data 4c.

The databases 31 to 34 described above are relational databases and have relations by which it is possible to find information intended for a certain model (part).

In the second embodiment, a database of information of troubles that occurred when a part was used in the past and prices of purchased parts may be provided in addition to the databases 31 to 34 described above. In this case, the database may be searched by using an ID (part ID) specifying a model to make additional information by adding further information to size and material.

In this case, a designer can discuss availability of an existing part by referring to past information. Further, it is possible to discuss necessity of development of a part based on price information.

According to the first embodiment and the second embodiment described above, even when about 100 GB of memory is consumed during search in an existing technique, the search can be performed by about 10 GB which is 1/10 of the existing technique, so that the search can be performed in a normal workstation.

Further, any of the first and the second embodiments can be sufficiently mounted on an accelerator such as GPU (Graphics Processing Unit), so that it is possible to construct a large-scale higher-speed shape search system by utilizing GPU.

Specifically, according to the first and the second embodiments, the number of digits of a floating-point arithmetic instruction is reduced by one. In other words, the time consumed by the search becomes 1/10. In current circumstances, when using a high-performance machine mounted with RAM of about 100 GB or more, a logical search time is 5.6 seconds. However, the machine is expensive and it is very difficult to realize the calculation time at present.

In the first and the second embodiments described above, the search time in the same environment is about 0.35 seconds without reducing the R visual line directions, and further the memory consumption can be about 1/10, so that the shape search can be easily performed by a single workstation.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A search method performed by a computer, the search method comprising:
calculating a high-dimensional feature vector and a low-dimensional feature vector, the number of dimensions of the low-dimensional feature vector which is smaller than the number of dimensions of the high-dimensional feature vector, from images of an object captured from different visual line directions;
specifying a search range of a similar image of a target object by using the low-dimensional feature vector; and
searching for the similar image that satisfies a predetermined selection criterion in the specified search range by using the high-dimensional feature vector.

2. The search method according to claim 1, comprising:
calculating the high-dimensional feature vector by using a first neural network that is made to learn a similar shape in a human sense; and
calculating the low-dimensional feature vector by using a second neural network to which the high-dimensional feature vector is inputted.

3. The search method according to claim 2, wherein the second neural network is a neural network, the number of neurons of which is reduced from the number of neurons of the first neural network.

4. The search method according to claim 3, wherein the second neural network specifies the search range by changing the selection criterion to a criterion made by adding a margin to the selection criterion.

5. The search method according to claim 1, comprising:
outputting additional information related to a shape associated with the searched similar image and a search result indicating the similar image.

6. The search method according to claim 1, therein the object has a three-dimensional shape.

7. The search method according to claim 1, further comprising:
rotating the object with respect to each of a plurality of coordinate axes and acquiring a plurality of two-dimensional images where the object is drawn from a fixed point of view; and
extracting a high-dimensional feature vector from each of the plurality of acquired two-dimensional images.

8. An information processing apparatus comprising:
a memory configured to store image data of an object captured from different visual line directions, a high-dimensional feature vector and a low-dimensional feature vector, the number of dimensions of the low-dimensional feature vector which is smaller than the number of dimensions of the high-dimensional feature vector, based on the image data of the object; and
a processor, coupled to the memory, configured to execute a process, the process including,
calculating the high-dimensional feature vector and the low-dimensional feature vector, from the image data of the object,
specifying a search range of a similar image of a target object by using the low-dimensional feature vector, and
searching for the similar image of the target object that satisfies a predetermined selection criterion in the specified search range by using the high-dimensional feature vector.

9. A non-transitory computer-readable recording medium having stored a program that causes a computer to execute a process, the process comprising:
calculating a high-dimensional feature vector and a low-dimensional feature vector, the number of dimensions of the low-dimensional feature vector which is smaller than the number of dimensions of the high-dimensional feature vector, from images of an object captured from different visual line directions;
specifying a search range of a similar image of a target object by using the law-dimensional feature vector; and
searching for the similar image of the target object that satisfies a predetermined selection criterion in the specified search range by using the high-dimensional feature vector.
